(19) United States
(12) Patent Application Publication
(10) Pub. No.: US 2020/0174702 A1
(43) Pub. Date: Jun. 4, 2020

(54) MEMORY SYSTEM, OPERATING METHOD THEREOF AND CONTROLLER

(71) Applicant: SK hynix Inc., Gyeonggi-do (KR)

(72) Inventor: Eu-Joon BYUN, Gyeonggi-do (KR)

(21) Appl. No.: 16/566,316

(22) Filed: Sep. 10, 2019

(30) Foreign Application Priority Data
Dec. 3, 2018 (KR) 10-2018-0153625

(51) Int. Cl. G06F 3/06

(52) U.S. Cl. CPC G06F 3/0659; G06F 3/0608; G06F 3/064; G06F 3/0673; G06F 3/0652

(57) ABSTRACT

A memory system includes a memory device including a plurality of memory blocks, and a controller suitable for selecting candidate memory blocks based on respective valid page counts of the plurality of memory blocks, grouping the selected candidate memory blocks into a victim memory block group, reading valid data stored in the victim memory block group from the memory device, and storing the valid data in one or more target memory blocks among the plurality of memory blocks.

### CROSS-REFERENCE TO RELATED APPLICATIONS

The present application claims priority under 35 U.S.C. § 119(a) to Korean Patent Application No. 10-2018-0153625, filed on Dec. 3, 2018, the disclosure of which is incorporated herein by reference in its entirety.

### BACKGROUND

### 1. Field

Various exemplary embodiments relate to a memory system and an operating method thereof, and more particularly, to a memory system capable of improving data processing efficiency and an operating method thereof.

### 2. Description of the Related Art

The computer environment paradigm has been transitioning to ubiquitous computing, which enables computing systems to be used anytime and anywhere. As a result, use of portable electronic devices such as mobile phones, digital cameras, and laptop computers has rapidly increased. These portable electronic devices generally use a memory system having one or more memory devices for storing data. A memory system may be used as a main memory device or an auxiliary memory device of a portable electronic device.

Since they have no moving parts, memory systems provide advantages such as excellent stability and durability, high information access speed, and low power consumption. Examples of memory systems having such advantages include universal serial bus (USB) memory devices, memory cards having various interfaces, and solid state drives (SSDs).

### SUMMARY

Various embodiments of the present invention are directed to a memory system capable of efficiently processing data.

In accordance with an embodiment, a memory system includes: a memory device including a plurality of memory blocks; and a controller suitable for: selecting candidate memory blocks based on respective valid page counts of the plurality of memory blocks, grouping the selected candidate memory blocks into a victim memory block group, reading valid data stored in the victim memory block group from the memory device, and storing the valid data in one or more target memory blocks among the plurality of memory blocks.

In accordance with an embodiment, an operating method of a memory system that includes a memory device including a plurality of memory blocks and a controller suitable for controlling the memory device, the operating method includes: selecting candidate memory blocks based on respective valid page counts of the plurality of memory blocks; grouping the selected candidate memory blocks into a victim memory block group; reading valid data stored in the victim memory block group from the memory device to the controller; storing the read valid data in a memory included in the controller; and storing the valid data, which is stored in the memory, in one or more target memory blocks among the plurality of memory blocks.

In accordance with an embodiment, a controller includes: a memory suitable for storing data to drive the controller; and a processor suitable for: selecting a plurality of candidate memory blocks, grouping the candidate memory blocks into a victim memory block group, reading valid data stored in the victim memory block group, storing the valid data in the memory, and storing the valid data, which is stored in the memory in a target memory block.

In accordance with an embodiment, a memory system includes: a memory device including a plurality of memory blocks; and a controller including a memory, suitable for: selecting a victim memory block group including candidate memory blocks among the plurality of memory blocks, based on valid page counts of the plurality of memory blocks; reading valid data in the memory; sorting the stored valid data; and storing the sorted valid data in at least one target memory block among the plurality of memory blocks.

### BRIEF DESCRIPTION OF THE DRAWINGS

FIG. 1 is a block diagram illustrating a data processing system including a memory system in accordance with an embodiment of the present invention.

FIG. 2 is a schematic diagram illustrating a memory device employed in the memory system.

FIG. 3 is a circuit diagram illustrating a memory cell array of a memory block in the memory device.

FIG. 4 is a block diagram illustrating an exemplary three-dimensional structure of the memory device.

FIG. 5A is a diagram schematically illustrating an operation of a memory system in accordance with an embodiment.

FIG. 5B is a flowchart illustrating an operating process of a memory system in accordance with an embodiment.

FIGS. 6A to 6C are diagrams schematically illustrating an operation of a memory system in accordance with embodiments.

FIG. 7 is a flowchart illustrating an operating process of a memory system in accordance with an embodiment.

FIGS. 8 to 16 are diagrams schematically illustrating application examples of the data processing system, in accordance with various embodiments of the present invention.

### DETAILED DESCRIPTION

Hereinafter, various embodiments of the present invention are described below in more detail with reference to the accompanying drawings. In the following description, only parts necessary for understanding the operation according to the present embodiments will be described, and the description of other parts will be omitted so as not to obscure the concept and point of the present embodiments.

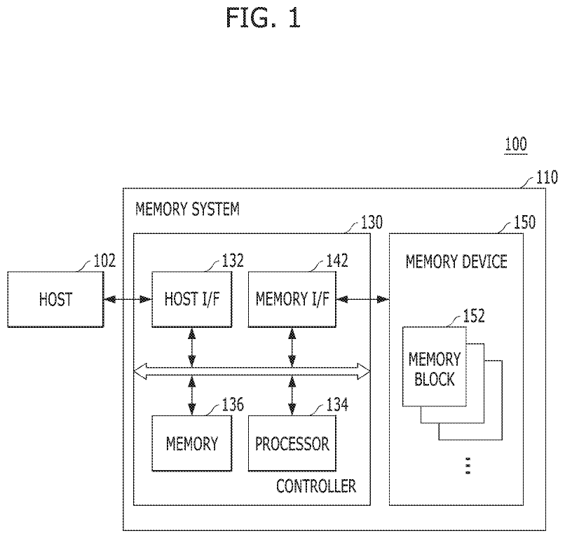

FIG. 1 is a block diagram illustrating a data processing system 100 in accordance with an embodiment of the present invention.

Referring to FIG. 1, the data processing system 100 may include a host 102 operatively coupled to a memory system 110.

The host 102 may include any of various portable electronic devices such as a mobile phone, MP3 player and laptop computer, or any of various non-portable electronic devices such as a desktop computer, a game machine, a television (TV), and a projector.

The host 102 may include at least one operating system (OS), which may manage and control overall functions and operations of the host 102, and provide operation between the host 102 and a user using the data processing system 100 or the memory system 110. The OS may support functions and operations corresponding to the use purpose and usage of a user. For example, the OS may be divided into a general OS and a mobile OS, depending on the mobility of the host 102. The general OS may be divided into a personal OS and an enterprise OS, depending on the environment of a user.

The memory system 110 may operate to store data for the host 102 in response to a request of the host 102. Non-limiting examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and the. The SD card may include a mini-SD card and micro-SD card.

The memory system 110 may be embodied by various types of storage devices. Examples of such storage devices may include, but are not limited to, volatile memory devices such as a dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM or ReRAM) and a flash memory.

The memory system 110 may include a controller 130 and a memory device 150.

The controller 130 and the memory device 150 may be integrated into a single semiconductor device. For example, the controller 130 and the memory device 150 may be integrated as one semiconductor device to constitute a solid state drive (SSD). When the memory system 110 is used as an SSD, the operating speed of the host 102 connected to the memory system 110 may be improved. In addition, the controller 130 and the memory device 150 may be integrated as one semiconductor device to constitute a memory card. For example, the controller 130 and the memory device 150 may constitute a memory card such as a personal computer memory card international association (PCMCIA) card, compact flash (CF) card, smart media (SM) card, memory stick, multimedia card (MMC) including reduced size MMC (RS-MMC) and micro-MMC, secure digital (SD) card including mini-SD card, micro-SD card and SDHC card, or universal flash storage (UFS) device. Non-limiting application examples of the memory system 110 may include a computer, a smart phone, a portable game machine, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory blocks 152 each of which may include a plurality of pages, and each of the pages may include a plurality of memory cells coupled to a word line. In an embodiment, the memory device 150 may be a flash memory. The flash memory may have a 3-dimensional (3D) stack structure.

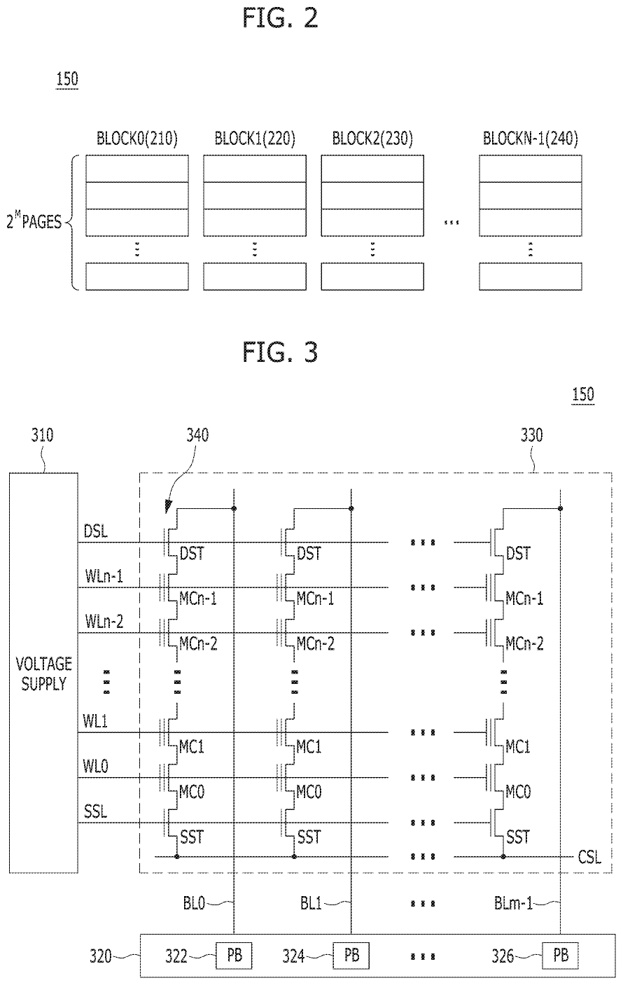

Since the structure of the memory device 150 including its 3D stack structure will be described in detail later with reference to FIGS. 2 to 4, further description of these elements and features are omitted here.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, program and erase operations of the memory device 150.

The controller 130 may include a host interface (I/F) 132, a processor 134, a memory I/F 142 such as a NAND flash controller (NFC), and a memory 144 all operatively coupled via an internal bus.

The host I/F 132 may be configured to process a command and data of the host 102, and may communicate with the host 102 through one or more of various interface protocols such as universal serial bus (USB), multi-media card (MMC), peripheral component interconnect-express (PCI-e or PCIe), small computer system interface (SCSI), serial-attached SCSI (SAS), serial advanced technology attachment (SATA), parallel advanced technology attachment (PATA), enhanced small disk interface (ESDI) and integrated drive electronics (IDE). The host I/F 132 may be driven through firmware referred to as a host interface layer (HIL) in order to exchange data with the host 102.

The memory I/F 142 may serve as a memory/storage interface for interfacing the controller 130 and the memory device 150 such that the controller 130 controls the memory device 150 in response to a request from the host 102.

The memory 144 may serve as a working memory of the memory system 110 and the controller 130, and store data for driving the memory system 110 and the controller 130.

The memory 144 may be embodied as a volatile memory. For example, the memory 144 may be embodied as a static random access memory (SRAM) or a dynamic random access memory (DRAM). The memory 144 may be disposed within or out of the controller 130. FIG. 1 exemplifies the memory 144 disposed within the controller 130. In an embodiment, the memory 144 may be embodied as an external volatile memory having a memory interface transferring data between the memory 144 and the controller 130.

As described above, the memory 144 may store data required for performing a data write/read operation between the host and the memory device 150, and data when the data write/read operation is performed. In order to store such data, the memory 144 may include a program memory, data memory, write buffer/cache, read buffer/cache, data buffer/cache, map buffer/cache or the like.

The processor 134 may control the overall operations of the memory system 110. The processor 134 may drive firmware to control the overall operations of the memory system 110. The firmware may be referred to as a flash translation layer (FTL). Also, the processor 134 may be realized as a microprocessor or a central processing unit (CPU).

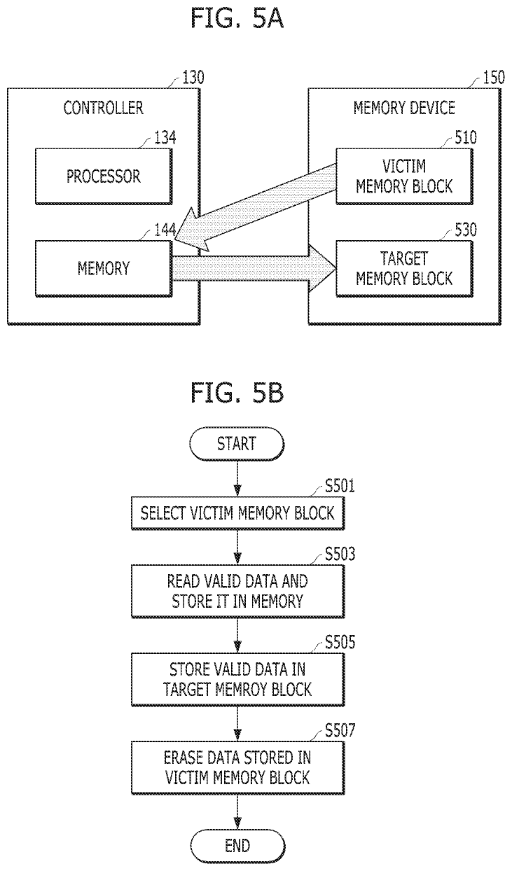

The controller 130 performs an operation requested from the host 102 in the memory device 150 through the processor 134. In other words, the controller 130 performs a command operation corresponding to a command received from the host 102 with the memory device 150. The controller 130 may also perform a background operation on the memory device 150. The background operation may include a garbage collection (GC) operation, a wear leveling (WL) operation, a map flush operation, a bad block management operation and so on. With reference to FIGS. 5A and 5B, the garbage collection operation will be described in detail.

Although not illustrated, the controller 130 may further include an error correction code (ECC) unit and a power management unit (PMU).

The ECC unit may correct error bits of data processed in the memory device 150, and include an ECC encoder and an ECC decoder.

The ECC encoder may generate data with a parity bit by performing error correction encoding on data to be programmed into the memory device 150, and the data with the parity bit may be stored in the memory device 150. The ECC decoder detects and corrects errors included in data read from the memory device 150 when reading the data stored in the memory device 150.

The ECC unit may perform error correction using low density parity check (LDPC) code, a Bose, Chaudhri, Hocquenghem (BCH) code, a turbo code, a Reed-Solomon code, a convolution code, a recursive systematic code (RSC) and coded modulation such as trellis-coded modulation (TCM) and block coded modulation (BCM). However, the present embodiment is not limited thereto. The ECC unit may include all of circuits, modules, systems or devices for correcting errors.

The PMU may provide and manage the power of the controller 130, i.e., the power of the components included in the controller 130.

A memory device of the memory system in accordance with an embodiment of the present invention is described in detail with reference to FIGS. 2 to 4.

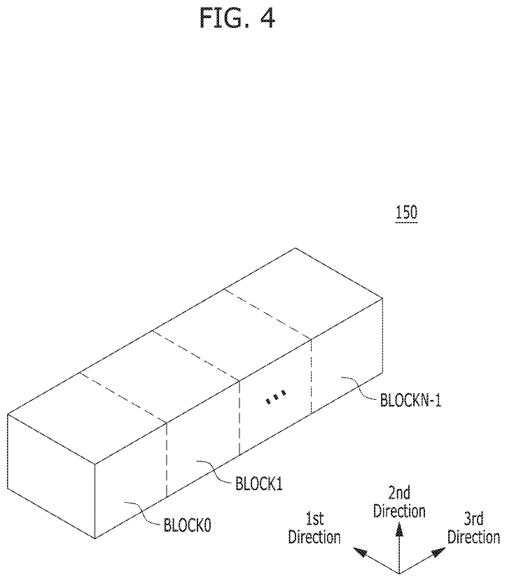

FIG. 2 is a schematic diagram illustrating the memory device 150. FIG. 3 is a circuit diagram illustrating a memory cell array of a memory block in the memory device 150. FIG. 4 is a schematic diagram illustrating an exemplary 3D structure of the memory device 150.

Referring to FIG. 2, the memory device 150 may include a plurality of memory blocks BLOCK0 to BLOCKN−1, e.g., BLOCK0 (210), BLOCK1 (220), BLOCK2 (230), and to BLOCKN−1 (240). Each of the memory blocks 210, 220, 230 and 240 may include a plurality of pages, for example 2^{M} pages, the number of which may vary according to circuit design. For example, in some applications, each of the memory blocks may include M pages. Each of the pages may include a plurality of memory cells that are coupled to a word line WL.

The memory device 150 may include multi level cell (MLC) memory blocks, triple level cell (TLC) memory blocks, quadruple level cell (QLC) memory blocks, and/or multiple level cell memory blocks. Each of the MLC memory blocks includes a plurality of pages that are realized by memory cells capable of storing two-bit data in one memory cell. Each of the TLC memory blocks includes a plurality of pages that are realized by memory cells capable of storing three-bit data in one memory cell. Each of the QLC memory blocks includes a plurality of pages that are realized by memory cells capable of storing four-bit data in one memory cell. Each of the multiple level cell memory blocks includes a plurality of pages that are realized by memory cells capable of storing five or more-bit data in one memory cell.

In accordance with an embodiment of the present invention, the memory device 150 is described as a non-volatile memory, such as a flash memory, e.g., a NAND flash memory. However, the memory device 150 may be realized as any of a Phase Change Random Access Memory (PCRAM), a Resistive Random Access Memory (RRAM or ReRAM), a Ferroelectric Random Access Memory (FRAM), a Spin Transfer Torque Magnetic Random Access Memory (STT-RAM or STT-MRAM).

The memory blocks 210 to 240 may store the data received from the host 102 through a program operation, and transfer data stored therein to the host 102 through a read operation.

Referring to FIG. 3, the memory device 150 of the memory system 110 may include a memory block 330. The memory block 330 may correspond to any of the plurality of memory blocks 152 in the memory device 150. The memory block 330 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells or memory cell transistors MC0 to MCn−1 may be coupled in series. In an embodiment, each of the memory cells MC0 to MCn−1 may be embodied by an MLC capable of storing data information having a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1. For reference, in FIG. 3, ‘DSL’ denotes a drain select line, ‘SSL’ denotes a source select line, and ‘CSL’ denotes a common source line.

Although FIG. 3 illustrates NAND flash memory cells, the invention is not limited in this way. It is noted that the memory cells may be NOR flash memory cells, or hybrid flash memory cells including two or more types of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply 310 which provides word line voltages including a program voltage, a read voltage and a pass voltage to supply to the word lines according to an operation mode. The voltage generation operation of the voltage supply 310 may be controlled by a control circuit (not illustrated). Under the control of the control circuit, the voltage supply 310 may select one of the memory blocks (or sectors) of the memory cell array, select one of the word lines of the selected memory block, and provide the word line voltages to the selected word line and the unselected word lines as may be needed.

The memory device 150 may include a read and write (read/write) circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

The memory device 150 may be embodied by a two-dimensional (2D) or three-dimensional (3D) memory device. Particularly, as illustrated in FIG. 4, the memory device 150 may be embodied by a nonvolatile memory device having a 3D stack structure. When the memory device 150 has a 3D structure, the memory device 150 may include a plurality of memory blocks BLOCK0 to BLOCKN−1.

Each memory block 330 in the memory device 150 may include a plurality of NAND strings NS that are extended in the second direction, and a plurality of NAND strings NS (not shown) that are extended in the first direction and the third direction. Each of the NAND strings NS may be coupled to a bit line BL, at least one drain select line DSL, at least one source select line SSL, a plurality of word lines WL, at least one dummy word line DWL (not shown), and a common source line CSL, and each of the NAND strings NS may include a plurality of transistor structures.

In short, each memory block 330 of the memory device 150 may be coupled to a plurality of bit lines BL, a plurality of drain select lines DSL, a plurality of source select lines SSL, a plurality of word lines WL, a plurality of dummy word lines DWL, and a plurality of common source lines CSL. Each memory block 330 may include a plurality of NAND strings NS. In each memory block 330, one bit line BL may be coupled to a plurality of NAND strings NS to realize a plurality of transistors in one NAND string NS. A drain select transistor DST of each NAND string NS may be coupled to a corresponding bit line BL, and a source select transistor SST of each NAND string NS may be coupled to a common source line CSL. Memory cells MC may be provided between the drain select transistor DST and the source select transistor SST of each NAND string NS. In other words, a plurality of memory cells may be realized in each memory block 330 of the memory device 150.

FIGS. 5A and 5B are diagrams illustrating an operation of a memory system 110 in accordance with an embodiment. By way of example, FIGS. 5A and 5B illustrate a process of performing the garbage collection operation among the background operations which the controller 130 performs on the memory device 150. Although the garbage collection operation is representatively described below, this is merely an example, and the present embodiment is not limited thereto.

FIG. 5A is a diagram schematically illustrating an operation of the memory system 110 in accordance with the embodiment.

Referring to FIG. 5A, the garbage collection operation may include an operation of searching for a region that is no longer usable or no longer needed among dynamically allocated memory regions and preparing for programming new data by erasing data in the region. The garbage collection operation may be performed in the memory system 110 without a request of the host 102.

The controller 130 may select a memory block (hereinafter referred to as a “victim memory block 510”) where data are erasable among a plurality of memory blocks in the memory device 150. In order to ensure space for storing large amounts of data or to perform the garbage collection (GC) operation or the wear leveling operation, the controller 130 may transfer valid data stored in the victim memory block 510 to a target memory block 530.

Specifically, the controller 130 may select the victim memory block 510 in the memory device 150. At this time, the controller 130 may preferentially select a memory block having the lowest number of valid pages as the victim memory block 510 among the plurality of memory blocks. The valid pages indicate pages storing valid data therein. The controller 130 may read the valid data from the victim memory block 510, store the read valid data in a memory 144 disposed in the controller 130, and then program victim data into the target memory block 530 in the memory device 150. The controller 130 may erase all the data stored in the victim memory block 510. The controller 130 may store new data in the victim memory block 510 where all the data are erased.

FIG. 5B is a flowchart illustrating an operating process of the memory system 110 in accordance with the embodiment.

Referring to FIG. 5B, in step S501, the controller 130 selects a victim memory block among a plurality of memory blocks in the memory device 150, based on a predetermined criterion. Particularly, the controller 130 selects a memory block as the victim memory block among the plurality of memory blocks, which has a valid page count greater than or equal to a predetermined threshold value. The operation of selecting the victim memory block may be performed under the control of the processor 134 in the controller 130.

In step S503, the controller 130 may load valid data in the victim memory block of the memory device 150 and store the loaded valid data in the memory 144 of the controller 130. At this time, the valid data in the victim memory block may be read from the memory device 150 and stored in the memory 144 under the control of the processor 134.

In step S505, the controller 130 may store the valid data of the memory 144 in a target memory block among the plurality of memory blocks in the memory device 150. Specifically, the processor 134 may control the memory 144 and the memory device 150 to store the valid data of the memory 144 in the target memory block. The target memory block may be a free memory block among the plurality of memory blocks in the memory device 150. The free memory block indicates a memory block in which no data are stored.

In step S507, the controller 130 may erase the data stored in the victim memory block. Specifically, the processor 134 may control the memory device 150 to erase the data stored in the victim memory block. At this time, the processor 134 may control the memory device 150 to erase invalid data as well as the valid data stored in the victim memory block.

As described above with reference to FIGS. 5A and 5B, the garbage collection operation is a preparation operation for efficiently performing a main operation which is to be performed at a later time, for example, a read operation and a write operation. Therefore, one way to improve the performance of the memory system 110 is to efficiently perform the garbage collection operation.

In order to efficiently perform the garbage collection operation, the controller 130 has to efficiently perform a first operation of copying the valid data from the victim memory block 510 to the target memory block 530 and a second operation of erasing the data stored in the victim memory block 510. Particularly, when the controller 130 efficiently performs the operation of selecting the victim memory block 510 in which the valid data is stored as the target of the garbage collection operation and the operation of storing the valid data in the target memory block 530 during the first operation, the efficiency of the garbage collection operation may be increased.

Hereinafter, the operation of the memory system 110 to select the victim memory block 510 and store the valid data in the target memory block 530 in accordance with embodiments will be described.

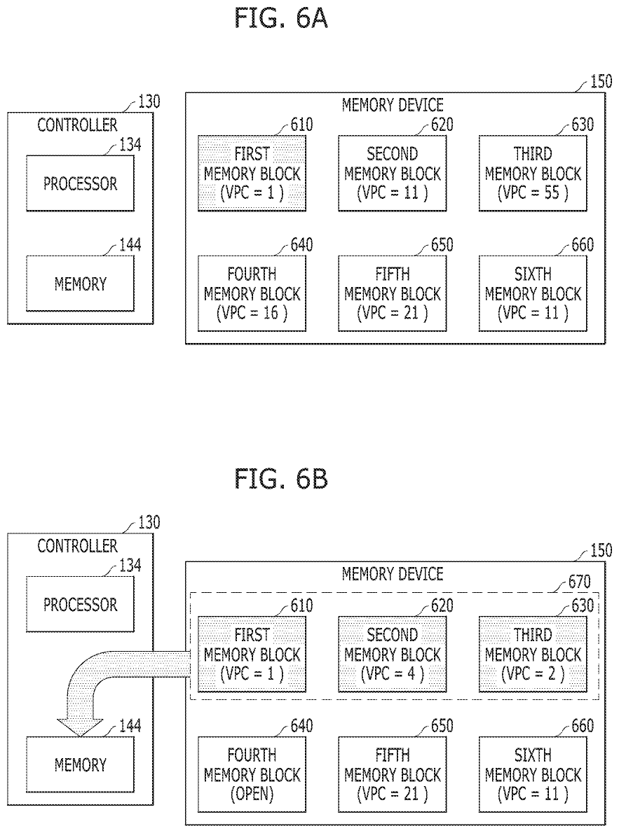

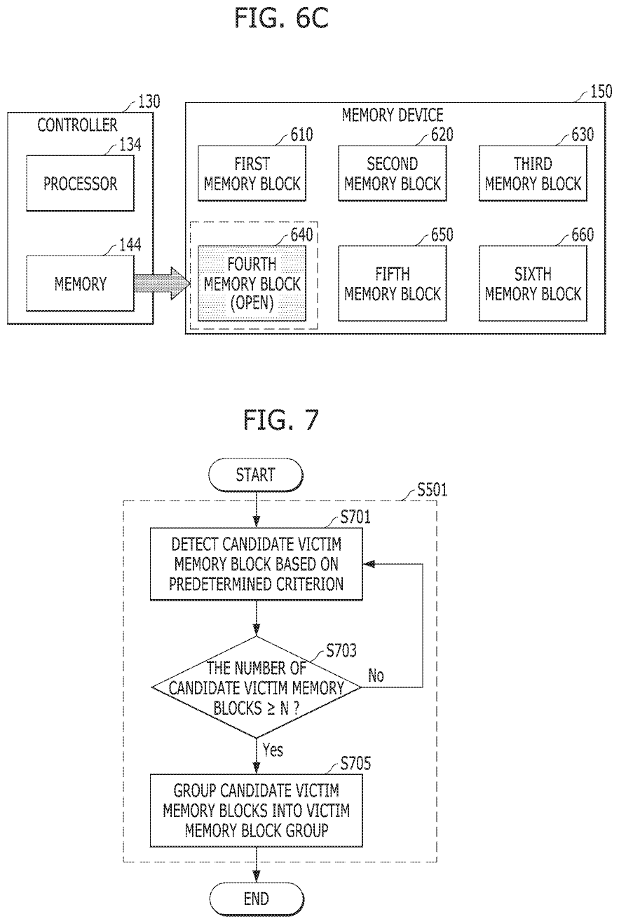

FIGS. 6A to 6C are diagrams schematically illustrating an operation of the memory system 110 in accordance with embodiments. By way of example, FIGS. 6A to 6C illustrate a process in which the memory system 110 performs the background operation. Hereinafter, the memory system 110 performs the garbage collection operation, and a first threshold value is ‘5’, and a second threshold value is ‘3’. However, other threshold values may be used for the first threshold value and the second threshold value. The first and second threshold values may be set by a designer. An operation of the controller 130 to be described below may be performed under the control of the processor 134.

The controller 130 may detect a candidate memory block among a plurality of memory blocks in the memory device 150 based on a predetermined criterion. Specifically, the controller 130 may search for the candidate memory block based on the number of valid pages (hereinafter referred to as a “valid page count, VPC”) corresponding to each of the plurality of memory blocks.

When there is a memory block of which the valid page count has a value less than the first threshold value, among the plurality of memory blocks, the controller 130 may select the memory block as the candidate memory block. At this time, when the number of candidate memory blocks is less than the second threshold value, the controller 130 may continue to detect the candidate memory block.

Referring to FIG. 6A, the controller 130 may check the valid page count of each of first to sixth memory blocks 610 to 660. For example, the valid page count of the first memory block 610 is ‘1’, the valid page count of the second memory block 620 is ‘11’, the valid page count of the third memory block 630 is ‘55’, the valid page count of the fourth memory block 640 is ‘16’, the valid page count of the fifth memory block 650 is ‘21’, and the valid page count of the sixth memory block 660 is ‘11’. Since the valid page count of the first memory block 610 is ‘1’, the controller 130 may select the first memory block 610 whose VPC has a value less than the first threshold value ‘5’, as the candidate memory block.

At this time, the candidate memory block is the first memory block 610 only. In other words, the number of candidate memory blocks is less than the second threshold value ‘3’. Therefore, the controller 130 may not perform the garbage collection operation on the first memory block 610 but continue to search for a candidate memory block.

Differently from the embodiment of FIG. 6A, when the number of candidate memory blocks is greater than or equal to the second threshold value ‘3’, the controller 130 may perform the garbage collection operation on a victim memory block group. The victim memory block group may include a plurality of candidate memory blocks selected by the controller 130. In other words, the controller 130 may read valid data stored in the victim memory block group, and store the valid data in the memory 144. Specifically, the processor 134 may control the memory device 150 to read valid data stored in the victim memory block group, and store the valid data provided from the memory device 150 in the memory 144.

Referring to FIG. 6B, the valid page count of the first memory block 610 is ‘1’, the valid page count of the second memory block 620 is ‘4’, the valid page count of the third memory block 630 is ‘2’, the fourth memory block 640 is an open block, the valid page count of the fifth memory block 650 is ‘21’, and the valid page count of the sixth memory block 660 is ‘11’. The controller 130 may select the first to third memory blocks 610, 620 and 630 having VPCs less than the first threshold value ‘5’ as candidate memory blocks. Since the number of candidate memory blocks is greater than or equal to the second threshold value ‘3’, the controller 130 may group the first to third memory blocks 610, 620 and 630 into a victim memory block group 670. Further, the controller 130 may read valid data stored in the victim memory block group 670, and store the valid data in the memory 144. Specifically, the processor 134 may control the memory device 150 to read the valid data stored in each of the first to third memory blocks 610, 620 and 630, and store the valid data from the memory 150 in the memory 144.

The controller 130 may sort the valid data stored in the memory 144 based on a predetermined criterion, and then store the sorted valid data in a target memory block in the memory device 150. For example, the controller 130 may sort the storage order of the valid data based on a logical address corresponding to each of the valid data stored in the memory 144, and store the valid data in the target memory block according to the sorted order. Further, the controller 130 may erase the data stored in the candidate memory blocks in the victim memory block group.

Referring to FIG. 6C, the controller 130 may sort valid data read from each of the first to third memory blocks 610, 620 and 630 based on a predetermined criterion. For example, the controller 130 may sort the data to be stored in the memory device 150 in ascending order of the logical addresses. When A data corresponding to a third logical address, B data corresponding to a first logical address and C data corresponding to a second logical address are stored in the memory 144 in the order described above, the controller 130 may sort the data to be stored in the memory device 150 in order of the B data, the C data and the A data based on the logical addresses. The controller 130 may store the data in the fourth memory block 640 according to the sorted order.

The controller 130 may erase the data stored in each of the first to third memory blocks 610, 620 and 630 in the victim memory block group 670. Subsequently, the controller 130 may store new data in each of the first to third memory blocks 610, 620 and 630 from which the data have been completely erased.

FIG. 7 is a flowchart illustrating an operating process of the memory system 110 in accordance with the embodiment. By way of example, FIG. 7 illustrates a process of selecting a victim memory block group. In other words, the step S501 illustrated in FIG. 5B may include steps S701 to S705 illustrated in FIG. 7.

Referring to FIG. 7, in step S701, the controller 130 may detect a candidate memory block among a plurality of memory blocks in the memory device 150 based on a predetermined criterion. For example, the controller 130 may detect a memory block whose VPC is less than the first threshold value (e.g., 5), as the candidate memory block.

In step S703, the controller 130 may determine whether the number of the detected candidate memory blocks is greater than or equal to the second threshold value ‘N’, where ‘N’ may be a natural number greater than 1, and be set by a designer.

When the number of the detected candidate memory blocks is less than the second threshold value (that is, “NO” in step S703), the controller 130 may continue to detect the candidate memory block.

When the number of the detected candidate memory blocks is greater than or equal to the second threshold value (that is, “YES” in step S703), the controller 130 may group the detected memory blocks into a single victim memory block group in step S705.

Subsequently, the controller 130 may perform the operations of steps S503 to S507 illustrated in FIG. 5B on the grouped memory blocks.

As described above, the memory system 110 in accordance with the present embodiments selects a plurality of victim memory blocks as a victim memory block group and performs the background operation on the victim memory block group at a time, thereby reducing the performance time to a greater level relatively to the background operation performed by selecting only one victim memory block. Furthermore, since the valid data, which are read from the plurality of victim memory blocks and stored in the memory 144, are re-sorted and then stored in the memory device 150, the performance of the read operation to be performed at a later time may also be improved. As a result, the overall operational performance of the memory system 110 may be improved.

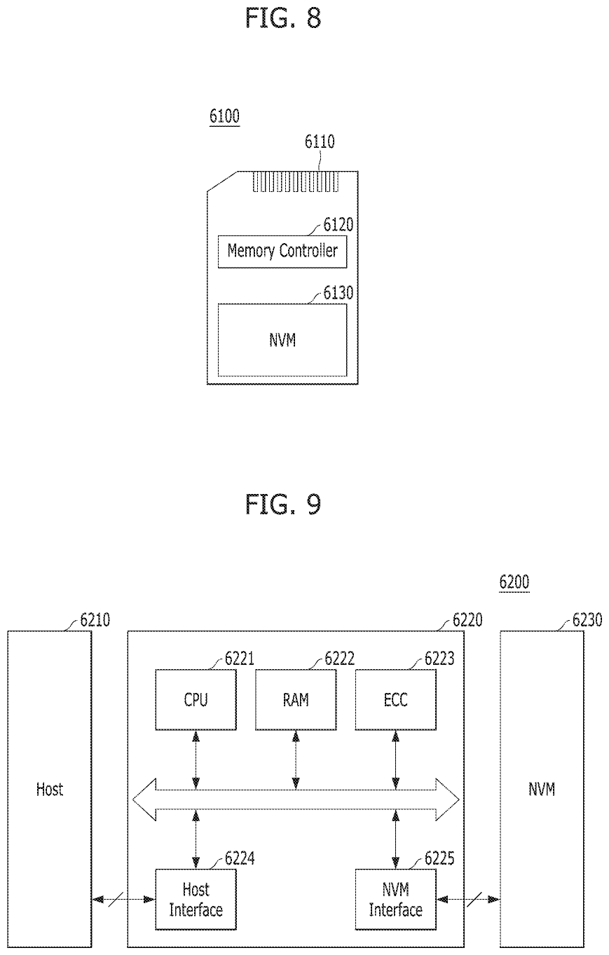

FIGS. 8 to 16 are diagrams schematically illustrating application examples of the data processing system of FIGS. 1 to 7 according to various embodiments.

FIG. 8 is a diagram schematically illustrating the data processing system including the memory system in accordance with an embodiment. By way of example, FIG. 8 illustrates a memory card system 6100 to which the memory system in accordance with an embodiment is applied.

Referring to FIG. 8, the memory card system 6100 may include a memory controller 6120, a memory device 6130 and a connector 6110.

The memory controller 6120 may be connected to the memory device 6130 embodied by a nonvolatile memory (NVM), and configured to access the memory device 6130. For example, the memory controller 6120 may be configured to control read, write, erase and background operations of the memory device 6130. The memory controller 6120 may be configured to provide an interface between the memory device 6130 and a host (not shown), and drive firmware for controlling the memory device 6130. That is, the memory controller 6120 may correspond to the controller 130 of the memory system 110 described with reference to FIG. 1, and the memory device 6130 may correspond to the memory device 150 of the memory system 110 described with reference to FIG. 1.

As shown in FIG. 1, the memory controller 6120 may include a random access memory (RAM), a processor, a host interface, a memory interface and an error correction component.

The memory controller 6120 may communicate with an external device, for example the host 102 of FIG. 1, through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), wireless fidelity (Wi-Fi or WiFi) and Bluetooth. Thus, the memory system and the data processing system in accordance with an embodiment may be applied to wired and/or wireless electronic devices, particularly mobile electronic devices.

The memory device 6130 may be implemented by a nonvolatile memory. For example, the memory device 6130 may be implemented by any of various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM).

The memory controller 6120 and the memory device 6130 may be integrated into a single semiconductor device. For example, the memory controller 6120 and the memory device 6130 may be integrated to form a solid-state drive (SSD). For another example, the memory controller 6120 and the memory device 6130 may form a memory card such as a PC card (e.g., Personal Computer Memory Card International Association (PCMCIA)), a compact flash (CF) card, a smart media card (e.g., SM and SMC), a memory stick, a multimedia card (e.g., MMC, RS-MMC, MMCmicro and eMMC), an secured digital (SD) card (e.g., miniSD card, microSD card and SDHC card) and a universal flash storage (UFS).

FIG. 9 is a diagram schematically illustrating another example of a data processing system 6200 including the memory system in accordance with an embodiment.

Referring to FIG. 9, the data processing system 6200 may include a memory device 6230 having one or more nonvolatile memories (NVMs) and a memory controller 6220 for controlling the memory device 6230. The data processing system 6200 may serve as a storage medium such as a memory card (CF card, SD card or the like) or USB device, as described with reference to FIG. 1. The memory device 6230 may correspond to the memory device 150 in the memory system 110 illustrated in FIG. 1, and the memory controller 6220 may correspond to the controller 130 in the memory system 110 illustrated in FIG. 1.

The memory controller 6220 may control a read, write or erase operation on the memory device 6230 in response to a request of the host 6210, and the memory controller 6220 may include one or more central processing units (CPUs) 6221, a buffer memory such as a random access memory (RAM) 6222, an error correction code (ECC) circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the memory device 6230 to operate at high speed.

The ECC circuit 6223 may correspond to the ECC component 138 of the controller 130 illustrated in FIG. 1. As described with reference to FIG. 1, the ECC circuit 6223 may generate an error correction code (ECC) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. The ECC circuit 6223 may correct an error using the parity bit. For example, as described with reference to FIG. 1, the ECC circuit 6223 may correct an error using Low Density Parity Check (LDPC) code, Bose-Chaudhri-Hocquenghem (BCH) code, turbo code, Reed-Solomon code, convolution code, Recursive Systematic Code (RSC) or coded modulation such as Trellis-Coded Modulation (TCM) or Block coded modulation (BCM).

The memory controller 6220 may transmit and/or receive data to and/or from the host 6210 through the host interface 6224, and transmit/receive data to/from the memory device 6230 through the NVM interface 6225. The host interface 6224 may be connected to the host 6210 through a parallel advanced technology attachment (PATA) bus, serial advanced technology attachment (SATA) bus, small computer system interface (SCSI), universal serial bus (USB), peripheral component interconnect-express (PCIe) or NAND interface. The memory controller 6220 may have a wireless communication function with a mobile communication protocol such as wireless fidelity (WiFi) or Long Term Evolution (LTE). The memory controller 6220 may be connected to an external device, for example, the host 6210 or another external device, and then transmit and/or receive data to and/or from the external device. In particular, as the memory controller 6220 is configured to communicate with the external device through one or more of various communication protocols, the memory system and the data processing system in accordance with an embodiment may be applied to wired and/or wireless electronic devices, particularly a mobile electronic device.

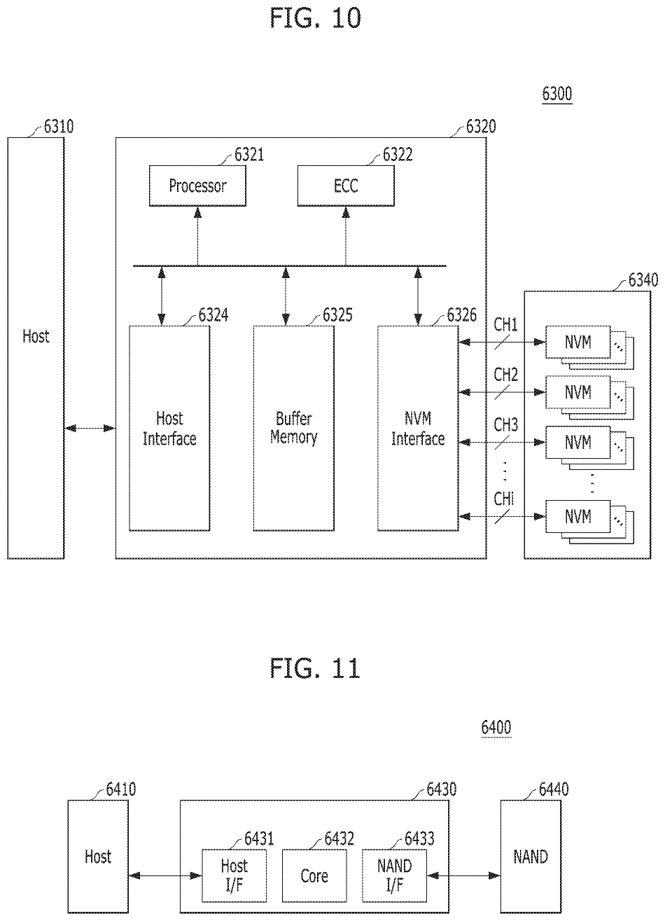

FIG. 10 is a diagram schematically illustrating another example of the data processing system including the memory system in accordance with an embodiment. By way of example, FIG. 10 illustrates a solid state drive (SSD) 6300 to which the memory system may be applied.

Referring to FIG. 10, the SSD 6300 may include a controller 6320 and a memory device 6340 including a plurality of nonvolatile memories (NVMs). The controller 6320 may correspond to the controller 130 in the memory system 110 of FIG. 1, and the memory device 6340 may correspond to the memory device 150 in the memory system of FIG. 1.

The controller 6320 may be connected to the memory device 6340 through a plurality of channels CH1 to CHi. The controller 6320 may include one or more processors 6321, an error correction code (ECC) circuit 6322, a host interface 6324, a buffer memory 6325 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as dynamic random access memory (DRAM), synchronous DRAM (SDRAM), double data rate (DDR) SDRAM, low power DDR (LPDDR) SDRAM and graphics RAM (GRAM) or nonvolatile memories such as ferroelectric RAM (FRAM), resistive RAM (RRAM or ReRAM), spin-transfer torque magnetic RAM (STT-MRAM) and phase-change RAM (PRAM). For convenience, FIG. 10 illustrates that the buffer memory 6325 exists in the controller 6320. However, the buffer memory 6325 may exist outside the controller 6320.

The ECC circuit 6322 may calculate an error correction code (ECC) value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310. The nonvolatile memory interface 6326 may provide an interface function with the memory device 6340 connected through the plurality of channels.

Furthermore, a plurality of SSDs 6300 to which the memory system 110 of FIG. 1 is applied may be provided to embody a data processing system, for example, a redundant array of independent disks (RAID) system. The RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

FIG. 11 is a diagram schematically illustrating another example of the data processing system including the memory system in accordance with an embodiment. By way of example, FIG. 11 illustrates an embedded Multi-Media Card (eMMC) 6400 to which the memory system may be applied.

Referring to FIG. 11, the eMMC 6400 may include a controller 6430 and a memory device 6440 embodied by one or more NAND flash memories. The controller 6430 may correspond to the controller 130 in the memory system 110 of FIG. 1, and the memory device 6440 may correspond to the memory device 150 in the memory system 110 of FIG. 1.

The controller 6430 may be connected to the memory device 6440 through a plurality of channels. The controller 6430 may include one or more cores 6432, a host interface (I/F) 6431 and a memory interface, for example, a NAND interface (I/F) 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, Ultra High Speed (UHS)-I and UHS-II interface.

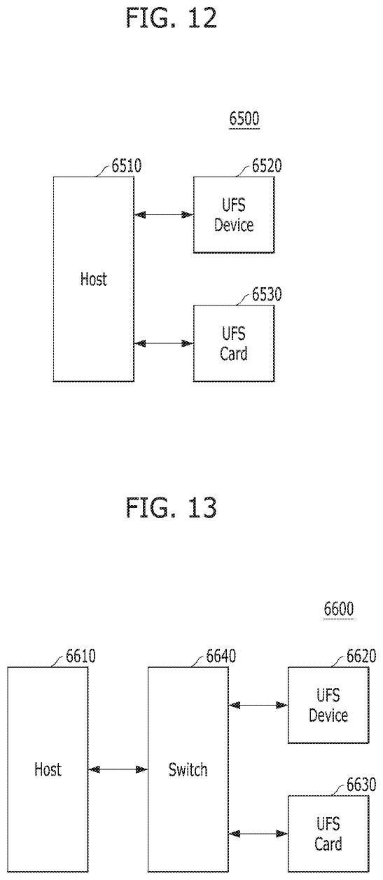

FIGS. 12 to 15 are diagrams schematically illustrating other examples of the data processing system including the memory system in accordance with one or more embodiments. By way of example, FIGS. 12 to 15 illustrate universal flash storage (UFS) systems to which the memory system may be applied.

Referring to FIGS. 12 to 15, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired and/or wireless electronic devices, particularly mobile electronic devices, the UFS devices 6520, 6620, 6720 and 6820 may serve as embedded UFS devices. The UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired and/or wireless electronic devices, particularly mobile electronic devices, through UFS protocols. The UFS devices 6520, 6620, 6720 and 6820 and the UFS cards 6530, 6630, 6730 and 6830 may be embodied by the memory system 110 illustrated in FIG. 1. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 9 to 11, and the UFS cards 6530, 6630, 6730 and 6830 may be embodied in the form of the memory card system 6100 described with reference to FIG. 8.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720 and 6820 and the UFS cards 6530, 6630, 6730 and 6830 may communicate with each other through various protocols other than the UFS protocol, for example, universal storage bus (USB) Flash Drives (UFDs), multi-media card (MMC), secure digital (SD), mini-SD, and micro-SD.

In the UFS system 6500 illustrated in FIG. 12, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. The UFS device 6520 and the UFS card 6530 may communicate with each other through link layer switching at the UniPro of the host 6510. In an embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6510, and a plurality of UFS cards may be connected in parallel or in the form of a star to the UFS device 6520 or connected in series or in the form of a chain to the UFS device 6520.

In the UFS system 6600 illustrated in FIG. 13, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In an embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

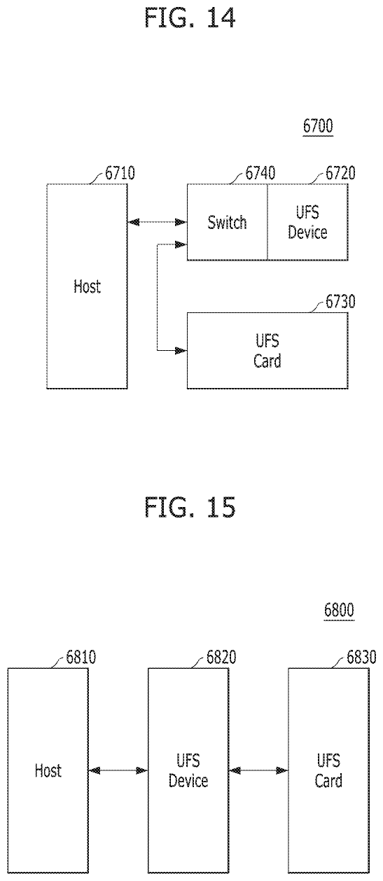

In the UFS system 6700 illustrated in FIG. 14, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. The UFS device 6720 and the UFS card 6730 may communicate with each other through link layer switching of the switching module 6740 at the UniPro, and the switching module 6740 may be integrated as one module with the UFS device 6720 inside or outside the UFS device 6720. In an embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710, or connected in series or in the form of a chain to each other. Furthermore, a plurality of UFS cards may be connected in parallel or in the form of a star to the UFS device 6720.

In the UFS system 6800 illustrated in FIG. 15, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target Identifier (ID) switching operation. The host 6810 and the UFS card 6830 may communicate with each other through target ID switching between the M-PHY and UniPro modules of the UFS device 6820. In an embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

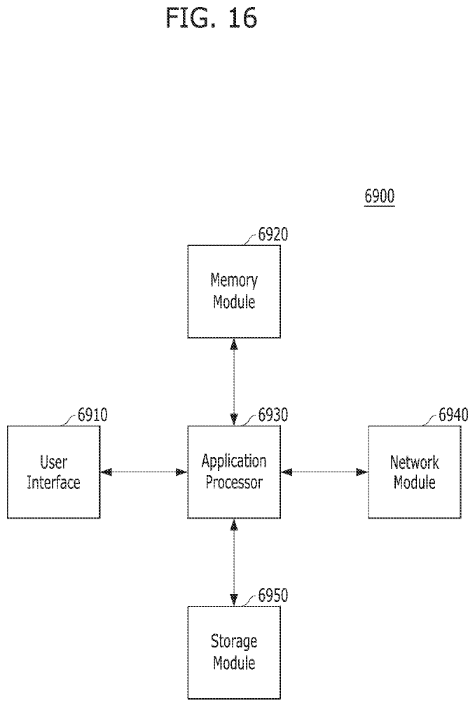

FIG. 16 is a diagram schematically illustrating another example of the data processing system including the memory system in accordance with an embodiment. By way of example, FIG. 16 is a diagram illustrating a user system 6900 to which the memory system may be applied.

Referring to FIG. 16, the user system 6900 may include a user interface 6910, a memory module 6920, an application processor 6930, a network module 6940, and a storage module 6950.

The application processor 6930 may drive components included in the user system 6900, for example, an operating system (OS), and include controllers, interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile random access memory (RAM) such as a dynamic RAM (DRAM), a synchronous DRAM (SDRAM), a double data rate (DDR) SDRAM, DDR2 SDRAM, DDR3 SDRAM, LPDDR SDARM, LPDDR2 SDRAM or LPDDR3 SDRAM or a nonvolatile RAM such as a phase-change RAM (PRAM), a resistive RAM (ReRAM), a magneto-resistive RAM (MRAM) or a ferroelectric RAM (FRAM). For example, the application processor 6930 and the memory module 6920 may be packaged and mounted, based on Package on Package (PoP).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIG. 1. Furthermore, the storage module 6950 may be embodied as an SSD, eMMC and UFS as described above with reference to FIGS. 10 to 15.

The user interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a monitor.

Furthermore, when the memory system 110 of FIG. 1 is applied to a mobile electronic device of the user system 6900, the application processor 6930 may control overall operations of the mobile electronic device, and the network module 6940 may serve as a communication module for controlling wired and/or wireless communication with an external device. The user interface 6910 may display data processed by the application processor 6930 on a display/touch module of the mobile electronic device, or support a function of receiving data from the touch panel.

The data processing system according to the embodiments of the present invention may efficiently perform a background operation.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a memory device including a plurality of memory blocks; and
a controller suitable for:
selecting candidate memory blocks based on respective valid page counts of the plurality of memory blocks,
grouping the selected candidate memory blocks into a victim memory block group,
reading valid data stored in the victim memory block group from the memory device, and
storing the valid data in one or more target memory blocks among the plurality of memory blocks.

2. The memory system of claim 1, wherein the controller includes:
a memory suitable for storing the valid data read from the memory device; and
a processor suitable for selecting the candidate memory blocks, grouping the selected candidate memory blocks into the victim memory block group, reading the valid data stored in the victim memory block group from the memory device, storing the valid data in the memory, and storing the valid data which is stored in the memory, in the one or more target memory blocks among the plurality of memory blocks in the memory device.

3. The memory system of claim 2, wherein the processor selects, as the candidate memory blocks, memory blocks whose valid page counts are greater than or equal to a first threshold value among the plurality of memory blocks.

4. The memory system of claim 2, wherein the processor groups the selected candidate memory blocks into the victim memory block group when the number of the selected candidate memory blocks is greater than or equal to a second threshold value, where the second threshold value is a natural number greater than 1.

5. The memory system of claim 2, wherein the processor stores the valid data in the memory, and erases the data stored in the victim memory block group.

6. The memory system of claim 2, wherein the processor sorts the valid data stored in the memory based on a predetermined criterion.

7. The memory system of claim 6, wherein the processor sorts the valid data based on a logical address corresponding to each piece of the valid data.

8. The memory system of claim 7, wherein the processor stores the valid data in the target memory blocks based on a sorted order.

9. A controller comprising:
a memory suitable for storing data to drive the controller; and
a processor suitable for:
selecting a plurality of candidate memory blocks, grouping the candidate memory blocks into a victim memory block group,
reading valid data stored in the victim memory block group, storing the valid data in the memory, and
storing the valid data, which is stored in the memory in a target memory block.

10. The controller of claim 9, wherein the processor selects, as the candidate memory blocks, memory blocks whose valid page counts are greater than or equal to a first threshold value among a plurality of memory blocks.

11. The controller of claim 9, wherein the processor stores the valid data in the memory, and erases the data stored in the victim memory block group.

12. The controller of claim 9, wherein the processor sorts the valid data based on a logical address corresponding to each of the valid data.

13. The controller of claim 9, wherein the processor stores the valid data in the target memory block based on a sorted order.

14. A memory system comprising:
a memory device including a plurality of memory blocks; and
a controller including a memory, suitable for:
selecting a victim memory block group including candidate memory blocks among the plurality of memory blocks, based on valid page counts of the plurality of memory blocks;
reading valid data of the victim memory block group;
storing the read valid data in the memory;
sorting the stored valid data; and
storing the sorted valid data in at least one target memory block among the plurality of memory blocks.

15. The memory system of claim 14, wherein the controller selects, as the candidate memory blocks, memory blocks whose valid page counts are greater than or equal to a first threshold value among the plurality of memory blocks.

16. The memory system of claim 14, wherein the processor generates the candidate memory blocks group when the number of the candidate memory blocks is greater than or equal to a second threshold value, where the second threshold value is a natural number greater than 1.

17. The memory system of claim 14, wherein the controller erases the stored valid data stored in the victim memory block group.

18. The memory system of claim 14, wherein the controller sorts the stored valid data based on a logical address corresponding to each piece of the valid data.
